(19) United States
(12) Patent Application Publication
(10) Pub. No.: US 2010/0264191 A1
(43) Pub. Date: Oct. 21, 2010

(54) Nail pin anchor setting tool

(76) Inventors: Patricia Lynne Foster, (US); Marvin Craig Herche, Genesce, WI (US)

Correspondence Address: PATRICIA FOSTER, 622 TWO RIVER DR., MUKWONAGO, WI, 53149, US

(21) Appl. No.: 12/426,237

(22) Filed: Apr. 18, 2009

(51) Int. Cl. B25C 7/00

(52) U.S. Cl. 227/147

(57) ABSTRACT

A one piece nail-pin anchor driver tool is provided for a power rotary hammer or percussion drill apparatus and is employed for setting nail-pin type anchors in a material such as concrete. The driver tool includes an end with a bore that fits over the concrete drill used to make the hole in the material such as concrete and a contoured end used to set the nail-pin into the anchor connected longitudinally along a common axis formed as a unified structure.

### FIELD OF THE INVENTION

The present invention relates to a tool for installing nail-pin and screw-pin anchors in connection with a rotary hammer or percussion drill with a masonry drill bit into materials such as concrete.

### BACKGROUND OF THE INVENTION

There are many types of anchors and fasteners that can be used to secure objects to concrete, brick, masonry, and stone walls. Many of these fasteners like the nail-pin and screw-pin anchor require a hole bored into the concrete. The hole is typically made with the use of a rotary hammer drill and a masonry drill bit. The anchor is then placed into the hole and the nail-pin or screw-pin is then forced into the sleeve portion of the anchor using a hammer or screw driver. These can be very hard to hit with the hammer when working overhead or in tight places where there is not enough room to swing a hammer. It also requires a good deal of force which cannot always be done with a hammer. A screw driver can be used to install the screw into the sleeve of the anchor, but this also can be awkward and difficult. The concrete nail pin anchor setting tool can be used with the hammer drill over the same concrete drill bit used to bore the hole in the concrete to ease in the installation of the anchor pin. The hammer force of the rotary hammer drill is transferred through the concrete nail-pin anchor setting tool and forces the nail-pin or screw-pin into the sleeve portion of the anchor. The tool sets the top of the nail-pin or screw-pin flush with the top of the anchor sleeve.

### SUMMARY OF THE INVENTION

The nail pin anchor setting tool is used with a rotary hammer drill and a concrete drill bit to ease the installation of nail-pin and screw-pin type anchors. The rotary hammer drill with the concrete drill bit is used to make the hole in a material such as concrete. The anchor is placed in the hole in the concrete. The concrete drill bit is then slid into the bore end of the nail-pin anchor setting tool. The drive end of the tool is placed against the head of the drive pin of the anchor and upon activation of the drill; the hammer force of the rotary hammer drill is transferred through the tool to the pin hammering the pin into the sleeve and setting the anchor into the concrete. The nail pin anchor setting tool is a single piece which can simple be slid on and off the drill making it easy to use.

### BRIEF DESCRIPTION OF THE DRAWINGS

FIG. 1 is a front perspective view of the present invention, which is aligned with a masonry bit in a rotary hammer; it is aligned with a nail-pin anchor before anchoring an angle bracket to a concrete block.

FIG. 2 is a plan view showing a first embodiment of the nail pin anchor setting tool.

FIG. 3 is a top view of the embodiment of the nail pin anchor setting tool shown in FIG. 1

FIG. 4 is a bottom view of the embodiment of the nail pin anchor setting tool shown in FIG. 1

FIG. 5 is a cross-sectional view of the embodiment of the nail pin anchor setting tool shown in FIG. 1

FIG. 6 is a perspective view of the embodiment of the nail pin anchor setting tool shown in FIG. 1

FIGS. 7A-7E sectional side plan views of the tool of the present invention as it is used to with a rotary hammer and concrete drill to install a nail or screw pin anchor.

### DESCRIPTION OF THE PREFERRED EMBODIMENT

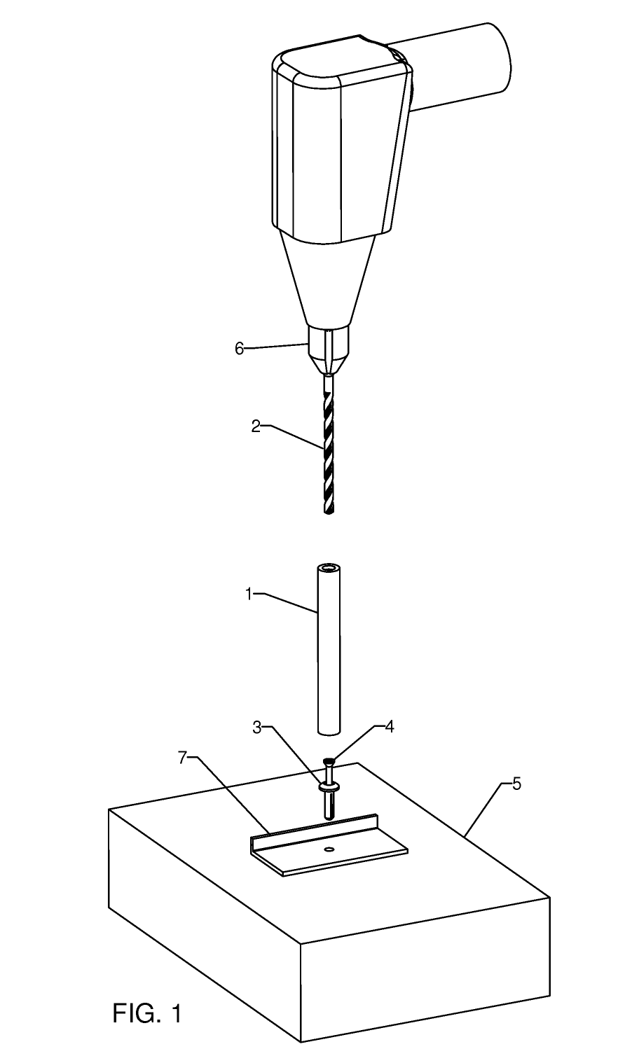

As shown in FIG. 1 the concrete nail-pin anchor setting tool 1 of the present invention is used with a rotary hammer drill 6 and a concrete drill bit 2 to drive a nail-pin or screw pin type anchor 3 through a hole in an angle iron bracket 7 into a drilled hole in a concrete block 5; the concrete nail-pin anchor setting tool 1 is then used to set the anchor pin 3 into the anchor sleeve 4 firmly attaching the iron bracket 7 to the concrete block 5.

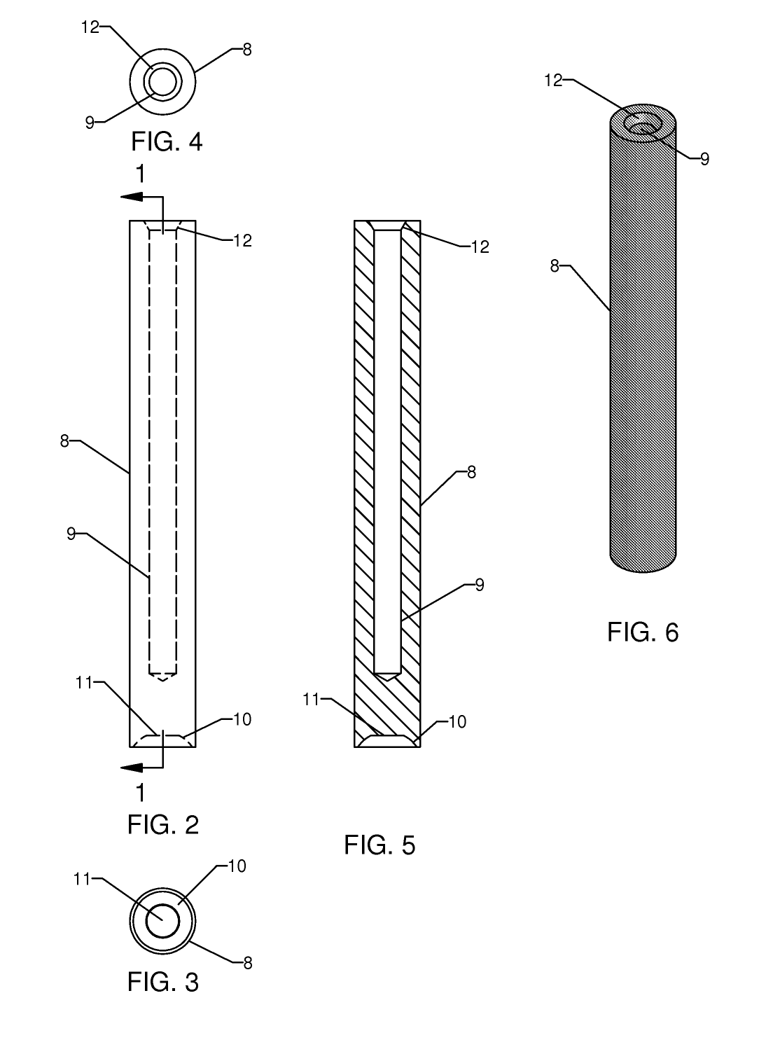

FIG. 2 shows the single piece concrete nail-pin anchor setting tool 1. The body 8 is made from a hard or hardened metal material such as 4140 steel.

FIG. 3 shows the drive end of the tool with the flat portion 11 that contacts the nail-pin and the concave spherical portion 10 which contacts the convex spherical portion of the anchor.

FIG. 4 shows the bore 9 end of the tool.

The section view FIG. 5 shows the interior construction of the present invention 1. The bore 9 is sized to fit precisely over the concrete drill bit and has a tapered portion 12 which contacts the tapered portion of the concrete drill bit. The contoured end has a concave spherical shape 10 that matches the convex spherical shape of the nail-pin anchor sleeve and a flat portion 11 that contacts the nail-pin.

FIG. 6 shows the body 8 of the tool, the bore 9 which receives the concrete drill bit, and the tapered portion 12 which the drill contacts.

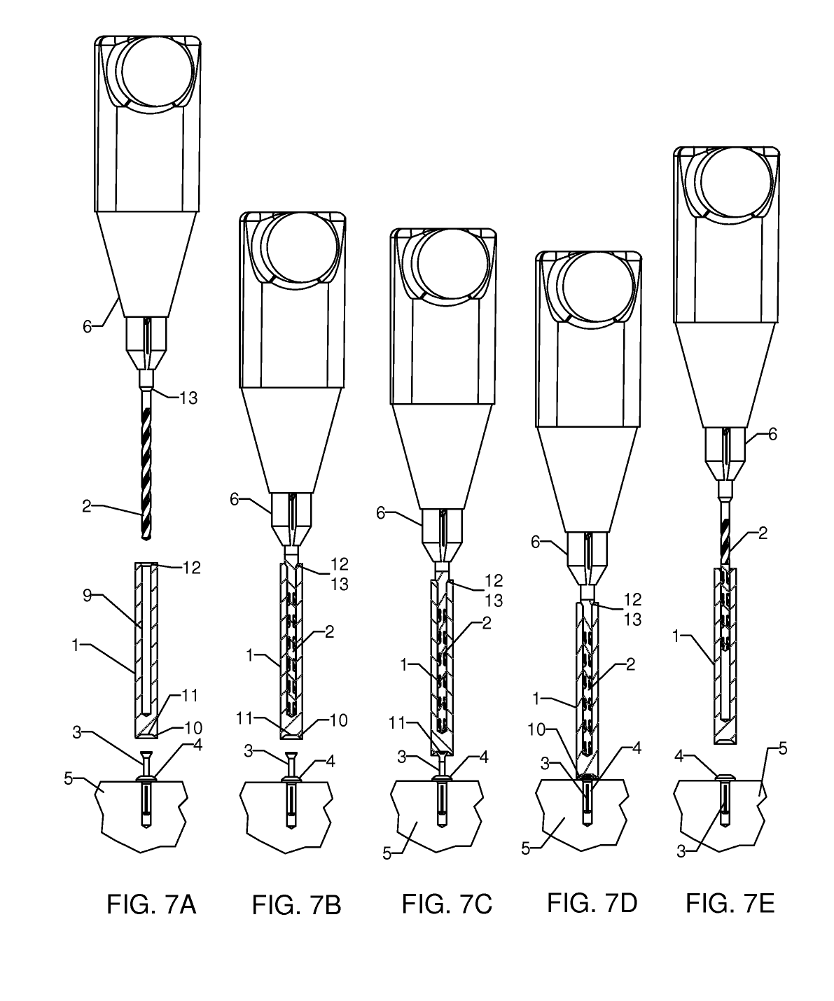

FIGS. 7A through 7E show sectional plan views of the tool 1 in use in the installation of the nail-pin anchor 3.

In FIG. 7A the hole has been drilled into the concrete block 5 with the concrete drill bit 2 and the rotary hammer drill 6. The anchor portion of the nail-pin anchor 4 has been inserted into the hole.

In FIG. 7B the concrete drill bit 2 has been inserted into the bore 9 of the tool 1. The tapered portion 12 of the tool 1 contacts the tapered portion 13 of the drill 2.

In FIG. 7C the flat portion 11 of the drive end of the tool 1 is placed on the flat head of the nail-pin 3.

As shown in FIG. 7D the hammering action of the rotary hammer drill 6 has been transmitted through the tool 1 driving the nail-pin 3 into the anchor sleeve 4 securing the nail-pin anchor 3 into the concrete block 5. The concave radius portion 10 of the tool 1 now rests upon the convex portion of the anchor sleeve 4.

FIG. 7E shows the concrete nail-pin anchor 3 secured into the concrete block 5 and the removal of the drill 2 from the tool 1 and the drill can then be used to drill another hole for another anchor 3

We claim:

1. A setting tool for use with a with a rotary hammer having a masonry drill bit for driving nail-pin and screw-pin anchors having nails and sleeves or screws and sleeves into concrete, the tool comprising of a single piece elongated cylindrical body member having a bore on one end and a drive end on the opposite end, the bore end having a tapered end and the drive end having a concaved shape with a flat bottom, the masonry drill bit is slid into the bore end and rests on the tapered portion, the flat of the bore end is placed on the head of the nail or screw of the anchor and the percussive force of the hammer drill is imparted through the tool which impacts the nail or screw driving it into the sleeve of the anchor, the concaved portion of the drive end contacts the convex portion of the nail-pin or screw-pin anchor sleeve signifying the anchor is assembled into the concrete.
